(19) United States
(12) Patent Application Publication
(10) Pub. No.: US 2012/0308962 A1
(43) Pub. Date: Dec. 6, 2012

(54) REMOVABLE DENTAL PROSTHESIS WITH FRAMEWORK AND SOFT BASE

(76) Inventor: Andrey Leonidovich KALININ, Moscow (RU)

(21) Appl. No.: 13/499,606

(22) PCT Filed: Sep. 22, 2010
(86) PCT No.: PCT/RU2010/000523

§ 371 Date: Jul. 28, 2012

(30) Foreign Application Priority Data
Sep. 30, 2009 (RU) 2009136078

(51) Int. Cl. A61C 13/105

(52) U.S. Cl. 433/195

(57) ABSTRACT

The invention relates to the field of prosthetic dentistry and can be used in the manufacture of removable dental prostheses. A removable dental prosthesis with a framework and a soft base comprises artificial teeth, a soft base made of silicone A, and a one-piece, perforated metal framework with a metal fastening element for the artificial teeth, said framework being situated inside the soft silicone A base. The artificial teeth fastening element is in the form of an arc situated about the centre of the alveolar process across the full width thereof and above the perforated metal framework, to which it is connected by connection sites having an analogous cross section. The one-piece, perforated metal framework is in the form of a one-piece plate having a cross section of from 0.3 mm to 0.5 mm and having openings with a diameter of from 1 mm across the entire surface of the framework. The one-piece, perforated metal framework is modeled together with the artificial teeth fastening element. The artificial teeth are secured to the fastening element using acrylic resin or different composite materials. The one-piece, perforated metal framework is connected to the soft silicone A base by mechanical attachment as a result of the openings. The technical result is that of firmly connecting all of the parts of a dental prosthesis and preventing the deformation and breakage thereof without increasing the overall weight.

### FIELD OF THE INVENTION

The invention is related to dentistry and tooth replacement in particular but can be used in the manufacture of removable dental prostheses.

### BACKGROUND

Nowadays removable acrylic dental prostheses with soft base are widely used in dentistry.

Complete removable acrylic dental prostheses with soft base comprise artificial teeth, a rigid acrylic base and a soft base made of acrylic flexible plastic, silicon-based basic materials or basic flexible plastic based on fluorine-containing rubber or polyvinyl chloride attached to the rigid base. The soft basis is attached to the rigid acrylic base along the entire contact surface due to adhesion. Removable dental prostheses with soft base possess certain elasticity achieving a more exact denture fit as compared to rigid dental prostheses and rubbing the gum to the lesser extent.

However, removable dental prostheses with soft base available today don't constitute such a dental prosthesis that could produce the minimum traumatized influence to the gums, occupy the least possible space in the oral cavity, please a patient from an esthetic point of view being comfortable and be used for a longer period of time.

It is related to the following circumstances. All soft elastic basic materials used in modern removable dental prostheses have a number of shortcomings in spite of advantages available. Acrylic soft resins lose their elasticity relatively fast.

Silicone-based elastic materials do not adhere enough to the plastic rigid base. Removable dental prostheses consisting of fluorine-containing rubber elastic materials require an expensive and ecologically dangerous manufacturing technique. Polyvinyl chloride elastic materials deteriorate fast with migration of a plasticizing agent.

Common shortcoming for all soft bases with application of elastic materials consists in their adjustment to the rigid base due to adhesion only increasing the total depth and total weight of a removable dental prosthesis while application of elastic materials in complete removable dental prostheses that are less than 1 mm deep don't allow to obtain the desired results due to increased elasticity of materials.

Thus, the task of manufacturing a more perfect dental prosthesis with soft base deprived of all the shortcomings mentioned above still constitutes a problem.

Bibliographic data of published data sources:
Zuboproteznaya tekhnika textbook [Dentoprosthetic Hardware] by V. N. Kopeikin and L. M. Demler. Chapter 8, “Izgotovleniye protezov pri polnom otsutstvii zubov” [Making of prostheses for no-teeth patients], p. 277-305. Published by Triada-X. Moscow, 2003.
Rukovodstvo po ortopedicheskoy stomatologii. Protezirovaniye pri polnom otsutstvii zubov [Prosthetic Dentistry Guide. Prosthetics for No-teeth Patients]. Edited by I. Yu. Lebedenko, E. S. Kalivradzhiyan, T. P. Ibragimov. 12.3.2. Elastichnye bazisnye polimery [Flexible Basis Polymers]. P. 241-243. Typography by Medical Information Agency, 2005, the city of Moscow.

### SUMMARY

The main objective of the present invention consists in developing of a complete removable dental prosthesis with soft base that ensures soft, complete and comfort adjustment of a dental prosthesis to the oral mucosa and better fitting of the removable dental prosthesis with the gum producing less traumatized influence to the oral and gingival mucosa.

Another objective of the present invention is development of a removable dental prosthesis with soft base and decreased wall depth having lesser weight as compared to similar available dental prostheses with soft base and increased resistance to working load.

One more objective of the invention is development of a removable dental prosthesis with soft base providing a reliable connection between separate elements of a dental prosthesis even in their small depth.

To solve the mentioned tasks it is offered to use a removable dental prosthesis with a framework and a soft base that comprises artificial teeth, a soft base of Silicone-A and a one-piece perforated metal framework with a metal fastening element for the artificial teeth situated inside the soft Silicone-A base and constituting one part with it. The metal fastening element for the artificial teeth is in the form of a metal arch with a cross section of 1-2.5 mm located around the center of the alveolar process along its entire length above the one-piece perforated metal framework with a cross section that is 0.3-0.5 mm deep and openings with diameters of more than 1 mm along the whole length of the framework.

Meanwhile, the one-piece perforated metal framework is shaped together with the fastening element for the artificial teeth and casted from metal, the artificial teeth being fixed to the fastening element with the help of cold- and heat-curing acrylic resins or different composite materials, whereas the one-piece perforated metal framework is connected with the silicone A soft base by mechanical fastening to the openings on the one-piece perforated metal framework.

It is preferable to provide for regular distribution of openings having a diameter of more than 1 mm along the entire surface of the framework.

To solve the mentioned tasks a framework for a removable dental prosthesis with soft base containing a one-piece perforated metal framework and metal fixing element for fastening the artificial teeth constituting one component with the one-piece perforated metal framework, the one-piece perforated metal framework being in the form of a one-piece metal plate shaped in accordance with the adjacent surface of the soft base with a cross section of 0.3-0.5 mm and openings with diameters of more than 1 mm along the surface of the plate.

The metal fastening element for the artificial teeth is in the form of a metal arch with a cross section of 1-2.5 mm located around the center of the alveolar process along its entire length above and at the distance of 1-3 mm of the one-piece perforated metal framework and attached to it with sites having a similar transverse section, the one-piece perforated metal framework being shaped and casted from metal together with the metal fastening element for the artificial teeth.

It is preferable to provide for regular distribution of openings having a diameter of more than 1 mm along the entire surface of the metal plate of the framework.

In the proposed removable dental prosthesis with soft base the total load is faced by the one-piece perforated metal framework with a metal fixing element for the artificial teeth, the load being directly transferred from the artificial teeth fastened to the metal fixing element with the help of acrylic plastic. The load is later distributed from the one-piece metal perforated framework via a soft silicone A base along the gingival surface to a rather large area producing less load to the gingiva and oral mucosa.

The proposed removable dental prosthesis with soft base is increasingly solid due to mechanical attachment of the soft base to the one-piece perforated metal plate with silicone A filling every opening of the plate.

Additional advantages, purposes and possibilities of the present invention will be reflected in the description below. It should be noted that the previous general description and subsequent detailed description are of explanatory origin and intended for additional explanation of the invention reflected in the formula of the latter.

### BRIEF DESCRIPTION OF THE FIGURES

Attached figures and photos included into the description for better understanding of the invention and constituting a part of the given description show how the invention can be realized and also explain the principles of the invention. The same elements occupy similar positions on figures and photos.

FIG. 1 shows a schematic section of a complete removable dental prosthesis with soft base in occlusion (the mouth is closed).

FIG. 2 shows the second section of a complete removable dental prosthesis with soft base with jaws open (the mouth is open).

FIG. 3-17 show photos illustrating the manufacturing process of the proposed removable dental prosthesis with soft base.

### DETAILED DESCRIPTION

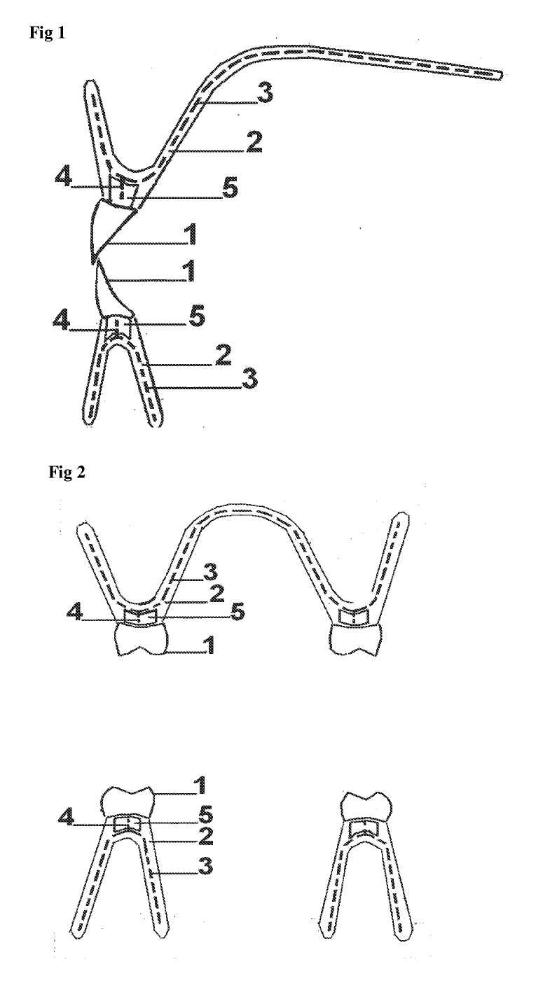

As it is shown on FIGS. 1 and 2, the removable dental prosthesis with framework and soft base embraces artificial teeth 1 made of plastic or other material, soft base 2 made of silicone-L, one-piece perforated metal framework 3 (broken line), metal fastening element 4 (broken line) and layer 5 consisting of acrylic plastic for fastening the artificial teeth 1 on a metal fixing element 4.

The one-piece perforated metal framework 3 is a one-piece perforated metal plate 6 with cross section that is 0.3-0.5 mm deep. Perforation on the metal plate consists of holes that are more than 1 mm in diameter along the entire surface of the metal plate (see FIGS. 10 and 14).

It is preferable to provide for regular distribution of the openings along the entire surface of the metal plate of the framework.

The metal fastening element 4 is a metal arc 8 with a cross section of 1-2.5 mm located along the center of the alveolar process along its entire length above the one-piece perforated metal framework 3 at the distance of 1-3 mm. The metal fastening element 4 is shaped separately with the perforating metal framework 3 constituting a single load-carrying construction. Attachment sites 9 of the metal fastening element 4 with perforated metal framework 3 have the same cross section as the metal fastening element 4. As it is going to be shown in the section describing manufacturing of the prosthetic device, the arc of the metal fastening element and its attachment site can be made of a wire of the same section. The metal fastening element 4 is preferably adjusted to the perforated metal framework 3 via 4-8 attachment sites.

The artificial teeth 1 can me manufactured of any material but as far as the examined example is concerned, the artificial teeth 1 are made of plastic. It has been already noted that the artificial teeth 1 are attached to the metal fastening element 4 with the help of cold- and heat-curing acrylic resins layer 5. To fasten the artificial teeth 1 on the metal fastening element 4 different composite materials can be used as well.

The one-piece perforated metal framework 3, which is the one-piece metal plate 6, is located inside the soft base 2 made of Silicone-A, forming with it a whole part. Silicone-A covers all sides of the one-piece perforated metal plate 6 of the one-piece perforated metal framework 3 and fills perforating holes 7 of the plate 6. Thus, the Silicone-A soft base 2 forms a single-piece unit with the one-piece perforated metal framework 3 not only due to adhesion of Silicone-A to the surface of the perforated metal plate 6, but also due to mechanical fastening of the one-piece metal perforated plate to the soft base with Silicone-A, filling perforating holes 7 of the plate 6. The soft base 2 also includes a layer 5 of acrylic plastic, and Silicone-A also fills the free space between the layer 5 of acrylic plastic and the one-piece perforated metal framework 3, further increasing the strength of the prosthesis. Silicone-A soft base 2 forms side walls and the palatal surface of the upper jaw prosthesis and side walls of the lower jaw prosthesis, so they have sufficient elasticity to gently cover the side surface of the gum regardless of it form, reducing the prosthesis traumatic effect on the gum. Silicone-A is chemically inert regarding to all food and does not interact with the oral mucosa.

Three functional layers can be found in the proposed removable dental prosthesis with a framework and a soft base: the first layer—plastic artificial teeth 1;

the second layer—the one-piece perforated metal framework 3 with a metal fastening element 4 which is integral with the one-piece perforated metal framework 3;

the third layer—Silicone-A soft base 2.

The first layer performs an aesthetic and practical function in the process of eating and communication.

The second layer is used for fixing artificial teeth 1 to the fastening element 4 with the help of cold- and heat-curing acrylic resins and for fixing Silicone-A soft base 2 on it, using both the adhesion between Silicone-A and the surface of the perforated metal plate 6 and mechanical fasteners by filling the holes (perforating holes) 7 in the metal plate 6 with Silicone-A, and also saves the specified configuration and provides the necessary strength of the assembly prosthesis.

The third layer: Silicone-A soft base 2 provides a soft thick comfortable fit of vestibular, oral and palatal surfaces of the upper jaw prosthesis, and oral and vestibular surfaces of the lower jaw prosthesis to the oral mucosa.

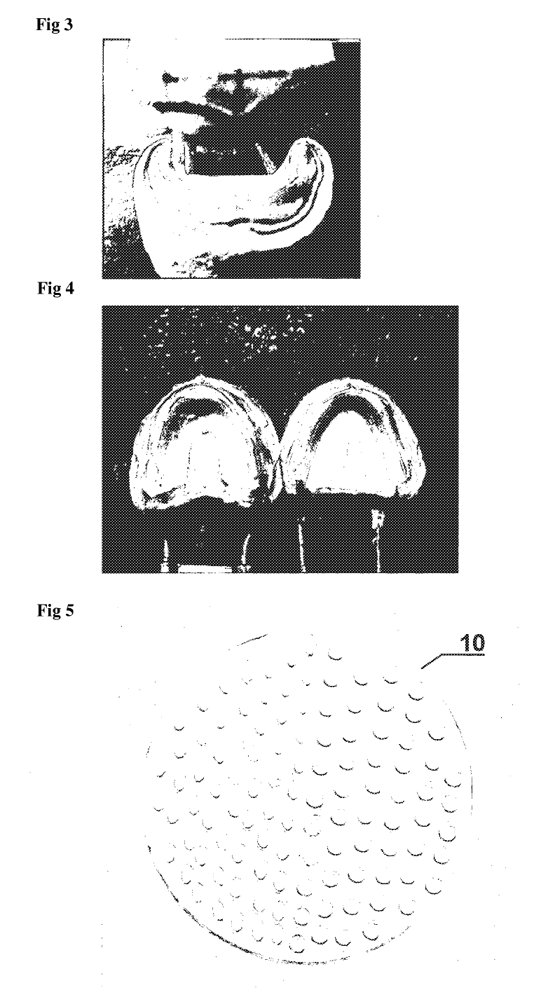

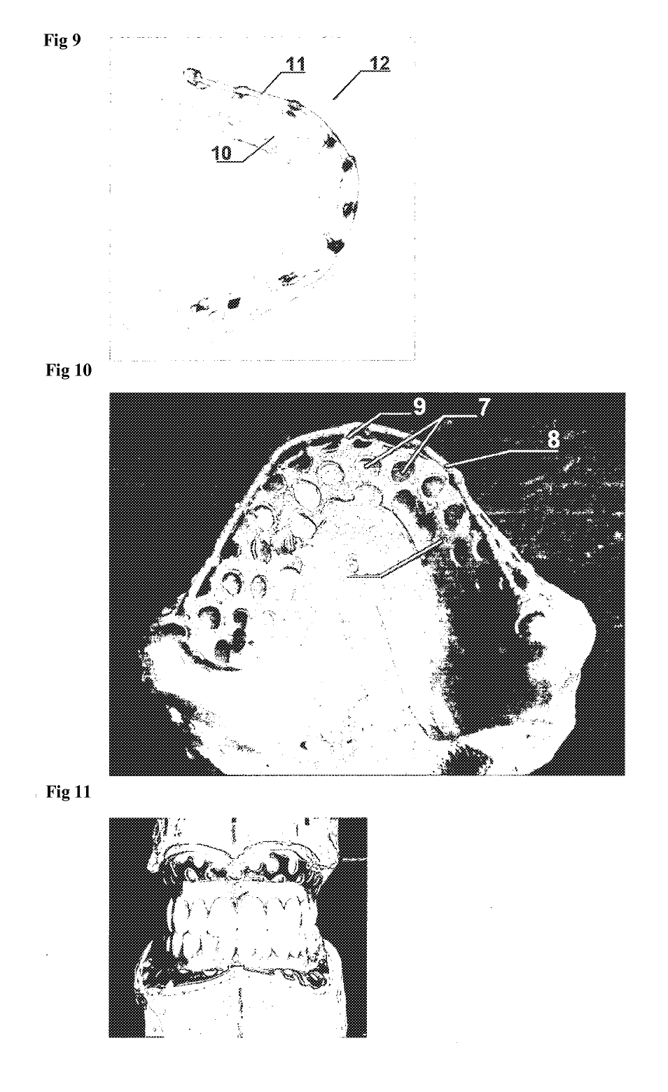

The proposed removable dental prosthesis with a framework and a soft base is manufactured as follows (See photo in FIG. 3-17).

Models of the upper and lower jaws and the occlusal template are made and fixed in an occludator or articulator. Using a wax plate, a space for a silicone soft base and surface for modeling of one-piece perforated metal framework 3 is formed (FIGS. 3 and 4). Then the perforated plate 10 of clasp wax (FIG. 5) is put on top of the first layer and the prepared model is pressed. Above the perforated plate 10 of clasp wax the metal fastening element 4 is modeled of the wax wire 11, locating a wax wire 11 along the arc at the center of the alveolar process at a given distance from the perforated plate of clasp wax.

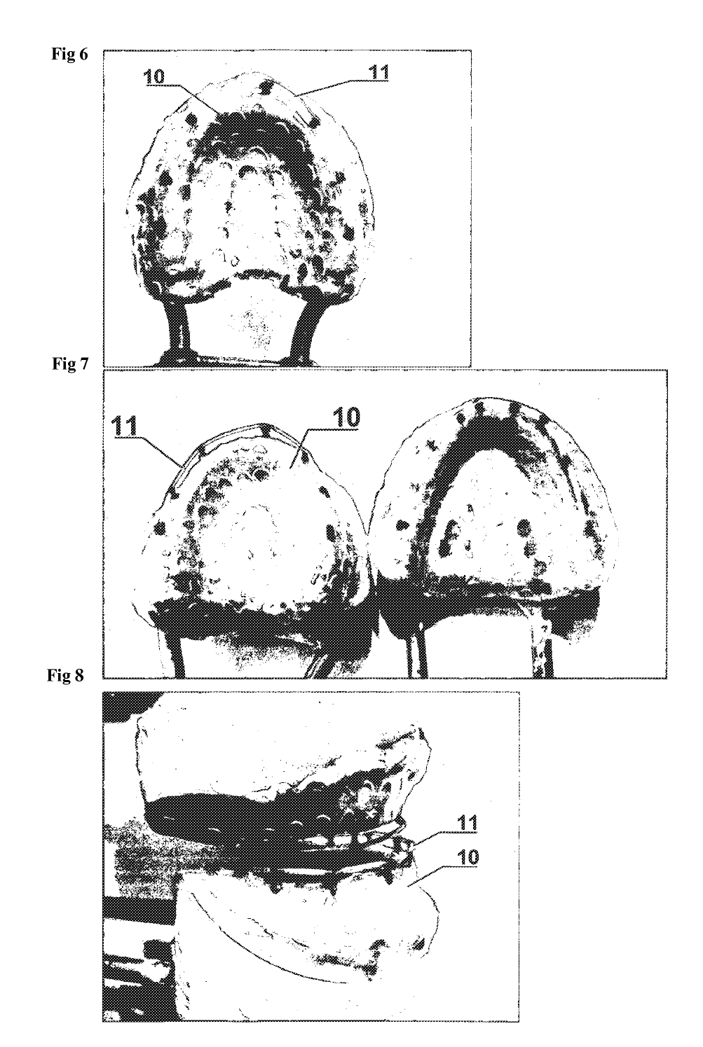

Then with the same wax wire it is connected to the molded-perforated plate 10 of clasp wax, the perforated plate of clasp wax is cut on a contour, following the contour of the one-piece perforated metal plate of the one-piece perforated metal framework. Then the obtained wax composition 12, which shapes the perforated metal framework with the metal fastening element (FIG. 6-9) is removed and transmitted to the casting shop.

The one-piece perforated metal framework 3 with metal fastening element 4 is made in a casting shop (FIG. 10). If necessary, it may be coated with, for example, titanium nitride or gold.

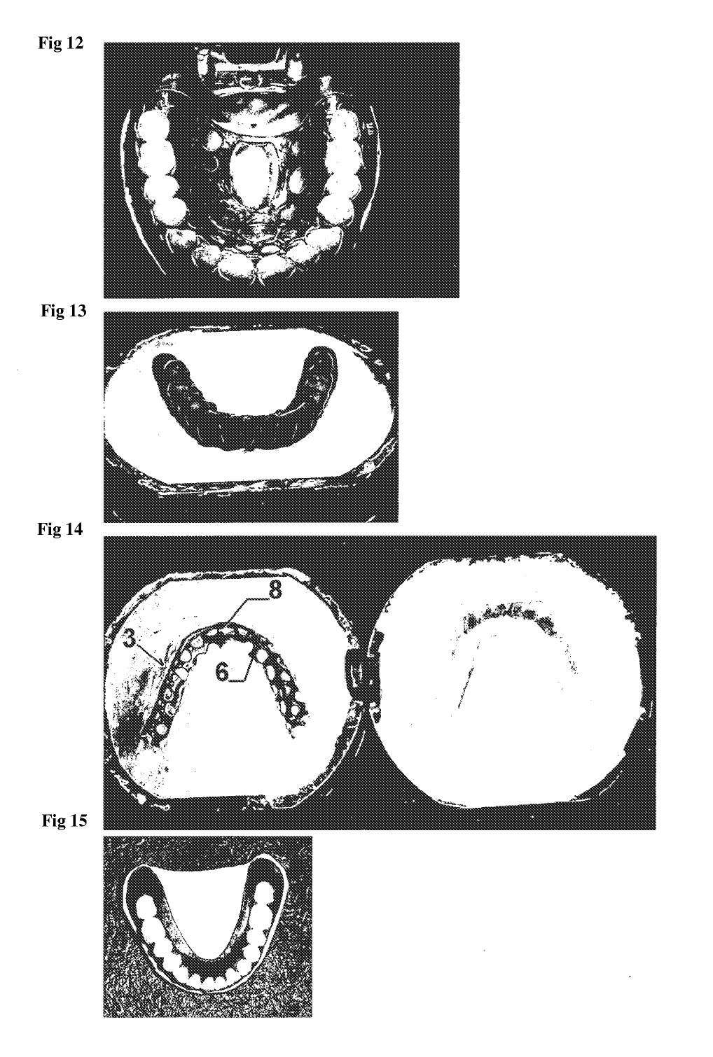

The wax rims are applied to the prepared one-piece perforated metal framework 3 with the metal fastening element 4 and artificial teeth 1 are placed according to the central occlusion (FIG. 11), specified by the doctor, and the placed teeth 1 are fixed on the metal fastening element 4 (FIG. 12-14).

The one-piece perforated metal framework with fixed teeth 1 is installed to the model and the final prosthesis modeling is performed (FIG. 15).

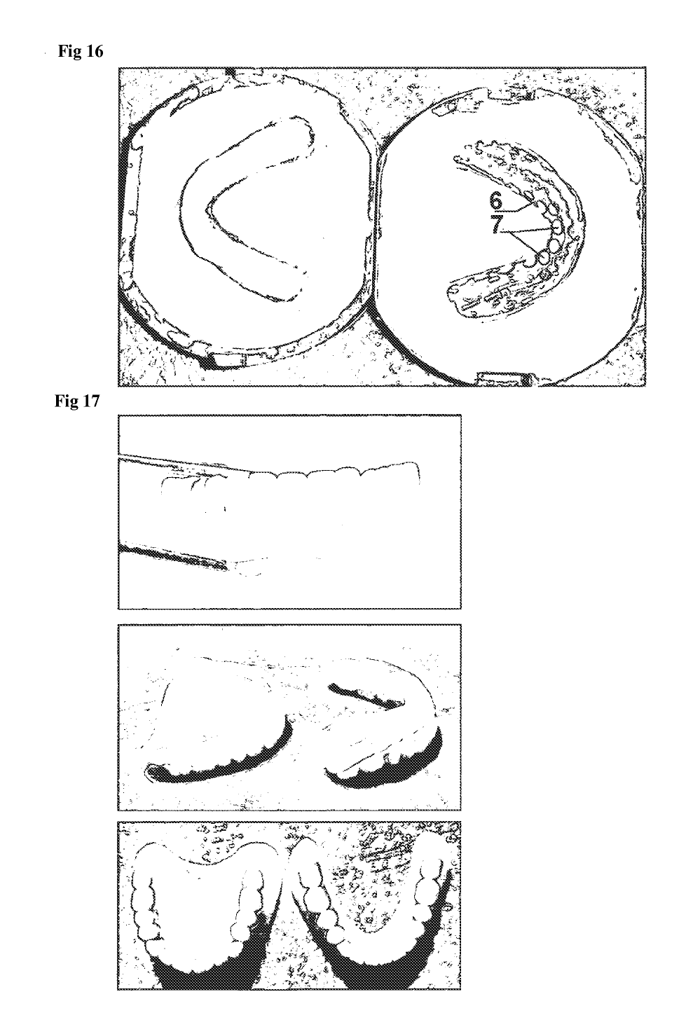

The modeled prosthesis is molded into a flask, the wax is removed and the soft base 2 is molded, polished and polymerized with Silicone-A (FIG. 16).

The ready removable prosthesis with framework and soft base is finished, polished and lacquered (FIG. 17).

The removable prosthesis with framework and soft base being proposed differs from the other known prototypes, usual removable laminar prostheses by the fact that there is no solid acrylic base in this design, and the main structural component is the one-piece perforated metal framework with metal fastening element for the artificial teeth, which make a whole with one-piece perforated metal framework.

In the result we have a possibility of manufacturing a complete removable prosthesis with soft base without increasing the overall thickness of the vestibular, oral or palatal surfaces of the prosthesis and its overall weight. The one-piece perforated metal framework with a metal fastening element for the artificial teeth provides for the firm connection of all parts of the prosthesis, and any possibility of deformation and breakage of the prosthesis is eliminated.

Although the specific example of utilization of the invention described refers to the whole dental prosthesis with the Silicone-A soft base and the plastic artificial teeth, it is obvious for those familiar with the art, that different silicone materials may be implemented, as well as the other artificial teeth materials: metals, porcelain, metal ceramics and composites applied in dentistry. It is also obvious that the proposed invention may be utilized to make partial removable prostheses, as appropriate.

This invention may be modified and altered without deviating from its nature and scope. It is therefore assumed, that this invention comprises modifications and alterations, which may be introduced therein, provided that they stay within the scope of the claims applied.

1. A removable dental prosthesis with a framework and a soft base, including artificial teeth, silicone soft base, and one-piece perforated metal framework with a metal fastening element for the artificial teeth, which is located inside the silicone soft base and forming with it a whole. In this case the metal fastening element for artificial teeth is a metal arc, having a cross-section of 1-2.5 mm located along the entire length of the center of the alveolar process above the one-piece perforated metal framework at a distance of 1 mm to 3 mm and sites attached to it which have a similar cross-section. The one-piece perforated metal framework is made in the form of a one-piece metal plate with a cross-sectional depth of 0.3-0.5 mm and with a hole that has a diameter of more than 1 mm, evenly distributed over the entire surface of the framework. The one-piece perforated metal framework is shaped together with the artificial teeth fastening element and casted from metal. The artificial teeth are fixed to the fastening element with cold- and heat-curing acrylic resins or various composite materials, while the one-piece perforated metal framework is connected to a silicone soft base by means of mechanical fastening through holes in the one-piece perforated metal framework.

2. The removable dental prosthesis with a framework to claim 1, where the holes with diameter of more than 1 mm are evenly distributed across the surface of the framework.

3. The removable dental prosthesis with a framework to claim 1, where the soft base is made of Silicone-A.

4. The framework for the removable dental prosthesis with a framework and a soft base containing one-piece perforated metal framework and metal fastening element for fixing artificial teeth, which is integrated with the one-piece perforated metal framework. The one-piece perforated metal framework is made in the form of a one-piece metal plate, shaped in accordance with the adjacent surface of the soft base, with a cross-sectional depth of 0.3-0.5 mm and with a hole that has 1 mm in diameter, located on the surface of the metal plate. The metal fastening element for fixing artificial teeth is a metal arc with a cross-section of 1-2.5 mm located along the entire length of the center of the alveolar process above the one-piece perforated metal framework at a distance of 1 mm to 3 mm away from it and attached to it with sites that have a similar cross-section. The one-piece perforated metal framework is shaped and casted from metal together with metal fastening element for artificial teeth.

5. The construction to claim 4, in which holes with diameter 1 mm are evenly distributed over the entire surface of the framework metal plate.
